(19) United States
(12) Patent Application Publication
(10) Pub. No.: US 2015/0269836 A1
(43) Pub. Date: Sep. 24, 2015

(54) CONFIGURABLE BI-DIRECTIONAL REMOTE CONTROL BASED ON SIGNAL INPUT DEVICE

(71) Applicant: Lucida Technology Co., Ltd., Changchun (CN)

(72) Inventor: Wei Huang, Changchun (CN)

(21) Appl. No.: 14/338,508

(22) Filed: Jul. 23, 2014

(30) Foreign Application Priority Data
Mar. 20, 2014 (CN) 201420129527.X
Apr. 4, 2014 (CN) 201420162075.5

(51) Int. Cl. G08C 17/00; G08C 23/00

(52) U.S. Cl. CPC G08C 17/00; G08C 23/00; G08C 2201/20; G08C 2201/92

(57) ABSTRACT

An electronic system includes a bi-directional remote control, a console device providing a display and a sound system, and a set of signal input devices connected to the console device. Each device in the set of signal input devices produces video and/or audio output that is transmitted to the console device for display and/or playback. The remote control communicates with the console device over a wireless link in both directions. The remote control allows a user to select a signal input device from the set. The console device switches to the selected signal input device and directs all user input, received from the remote control and entered using one or more user input devices connected to the console device, to the selected signal input device. The remote control reconfigures its input system based on the selected signal input device.

### CROSS REFERENCE TO RELATED APPLICATIONS

This application claims the benefit and priority of People's Republic of China Patent Application Number 201420129527.X, filed Mar. 20, 2014, which is hereby incorporated by reference. This application also claims the benefit and priority of People's Republic of China Patent Application Number 201420162075.5, filed Apr. 4, 2014, which is hereby incorporated by reference.

### FIELD OF THE DISCLOSURE

The present invention relates to a remote control device for remotely controlling a second electronic device, and more particularly relates to a bi-directional remote control that is configurable depending on a currently selected signal input device to a second electronic device. More particularly still, the present invention relates to an electronic device system including a bi-directional remote control that is configurable depending on a currently selected signal input device to a second electronic device.

### DESCRIPTION OF BACKGROUND

A remote control is an electronic device allowing a user to remotely operate a second electronic device without having to make a physical contact with the second electronic device. The remote control receives the user's input and communicates one or more commands indicating the input to the second electronic device over a wireless link, such as an infra-red (“IR”) link, a WiFi link, a Bluetooth link, or a different wireless connection. The commands are represented and carried by wireless signals, such as IR signals, sent from the remote control to the second electronic device. Television (“TV”) or DVD player remote controls are commonly available and used.

Traditional remote controls are capable of one-way communication only. In other words, traditional remote controls are capable of sending signals to a controlled device (such as a TV or a DVD player), but not capable of receiving signals from the controlled device. Two-way remote controls have been suggested and proposed in recent years. For example, U.S. Pat. No. 6,255,961 teaches a two-way remote control. In other words, the communication between the remote control and the audio/visual device in the U.S. Pat. No. 6,255,961 is bi-directional. Under the U.S. Pat. No. 6,255,961, the two-remote control directly communicates with each of the controlled devices, i.e., the audio/visual devices.

A console electronic device, such as a TV, is oftentimes connected to more than one external signal input devices. In such a a case, the console electronic device serves as, for example, a display device for the external signal input devices. The external signal input devices, such as a video game device, a DVD player, a laptop computer, etc., provides input signals to the console electronic device. The input signals can be audio and/or video signals. For example, the video signals generated by a video game device (such as a PlayStation or an Xbox) or a DVD player are sent to the console electronic device, which then displays video images corresponding to the video signals on a display screen of the console device. Similarly, the audio signals generated by the video game device or the DVD player are sent to the console electronic device, which then plays back sound corresponding to the audio signals through one or more speakers connected to the console device.

Accordingly, it is desirable that a remote control is provided to remotely operate the console electronic device (or console device for short) and the external signal input devices. The console device is usually configured to process signals from a single external signal input device at any point in time. In other words, only one external signal input device is selected as the source input device for the console device. For example, a user uses the remote control to select a video game device when he desires to play a video game. In such a case, the video game device is designated as the currently selected signal input device of the console device. As an additional example, the user uses the remote control to select a DVD player when he desires to watch a movie. The screen of the console device displays the image frames of the movie while the speakers of the console device plays back sound of the movie. In such a case, the DVD player is the currently selected signal input device of the console device.

The external signal input devices usually have different operation commands and interfaces. The same input key on a remote control device usually functions differently for different external signal input devices. For example, in response to the pressing and holding down of the same button of the remote control, a video game device acts differently than a DVD player. The pressing and holding down of an “Up” key may cause the video game device to accelerate the movement of an object within a video game. In contrast, the pressing and holding down of the “Up” key may only cause the DVD player to increase sound volume by one level or highlight a menu item. In such a case, it is desirable for the remote control to be reconfigured such that its input system (such as a set of buttons and/or keys) is reconfigured depending on the selected external signal input device.

Accordingly, there is a need for a bi-directional remote control that is reconfigurable depending on the selected signal input device. The bi-directional remote control receives signals and commands from the console device when a different external signal input device is selected. In response, the remote control reconfigures its input system for operating the selected external signal input device.

### OBJECTS OF THE DISCLOSED SYSTEM, METHOD, AND APPARATUS

Accordingly, it is an object of this disclosure to provide a bi-directional remote control.

Another object of this disclosure is to provide a bi-directional remote control for remotely operating a console device and a set of external signal input devices connected to the console device.

Another object of this disclosure is to provide a bi-directional remote control that is reconfigurable depending on the selection of a signal input device connected to a console device.

Another object of this disclosure is to provide a bi-directional remote control whose input system is reconfigurable depending on the selection of a signal input device connected to a console device.

Other advantages of this disclosure will be clear to a person of ordinary skill in the art. It should be understood, however, that a system or method could practice the disclosure while not achieving all of the enumerated advantages, and that the protected disclosure is defined by the claims.

### SUMMARY OF THE DISCLOSURE

Generally speaking, pursuant to the various embodiments, the present disclosure provides a bi-directional remote control. The bi-directional remote control includes a controller, and a first transceiver operatively coupled to the controller. The first transceiver is adapted to send wireless signals to and receive wireless signals from a second transceiver of a console device. The bi-directional remote control also includes a user input device operatively coupled to the controller. The user input device includes a signal switch key. In addition, the bi-directional remote control includes a set of user input processing programs corresponding to a set of external signal input devices operatively coupled to the console device. Each program in the set of user input processing programs is adapted to be executed by the controller for preprocessing user input entered using the user input device. The controller is adapted to send a signal input device switch command using the first transceiver to the console device when the signal switch key is operated. The console device selects an active signal input device operatively coupled to the console device in response to the signal input device switch command, and sends a signal input device switched command to the remote control using the second transceiver. The controller is also adapted to receive the signal input device switched command using the first transceiver. The signal input device switched command indicates the active signal input device. The controller is further adapted to, from the set of user input processing programs, select an active input processing program corresponding to the active signal input device in response to the signal input device switched command. Moreover, the controller is adapted to send user input entered using the user input device and preprocessed by the active input processing program to the console device using the first transceiver.

Further in accordance with the present teachings is an electronic console device. The electronic console device includes a controller supporting a set of input interfaces for receiving signals from a set of external signal input devices, and a first transceiver operatively coupled to the controller. The first transceiver is adapted to send wireless signals to and receive wireless signals from a second transceiver of a bi-directional remote control. The electronic console device also includes a video device operatively coupled to the controller. The video device is adapted to display video images received from the set of external signal input devices. In addition, the electronic console device includes a signal switch device operatively coupled to the controller and the set of external signal input devices. The controller is adapted to receive a signal input device switch command from the bi-directional remote control using the first transceiver, and, responsive to the signal input device switch command, select an active signal input device from the set of external signal input devices using the signal switch device. The controller is also adapted to send a signal input device switched command to the bi-directional remote control using the first transceiver, receive user input entered using the bi-directional remote control, and direct the user input to the active signal input device.

### BRIEF DESCRIPTION OF THE DRAWINGS

Although the characteristic features of this disclosure will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a simplified block diagram of an electronic system including a bi-directional remote control, a console device and a set of external signal input devices operatively coupled to the console device in accordance with the teachings of this disclosure;

FIG. 2 is a simplified block diagram of a bi-directional remote control in accordance with the teachings of this disclosure;

FIG. 3 is a simplified block diagram of an electronic console device and a set of external signal input devices in accordance with the teachings of this disclosure;

FIG. 4 is a sequence diagram depicting a process by which an electronic system switches external signal input devices in accordance with the teachings of this disclosure;

FIG. 5 is a sequence diagram depicting a process by which an electronic system switches external signal input devices in accordance with the teachings of this disclosure; and

FIG. 6 is a front view of a bi-directional remote control in accordance with the teachings of this disclosure.

A person of ordinary skills in the art will appreciate that elements of the figures above are illustrated for simplicity and clarity, and are not necessarily drawn to scale. The dimensions of some elements in the figures may have been exaggerated relative to other elements to help understanding of the present teachings. Furthermore, a particular order in which certain elements, parts, components, modules, steps, actions, events and/or processes are described or illustrated may not be actually required. A person of ordinary skills in the art will appreciate that, for the purpose of simplicity and clarity of illustration, some commonly known and well-understood elements that are useful and/or necessary in a commercially feasible embodiment may not be depicted in order to provide a clear view of various embodiments in accordance with the present teachings.

### DETAILED DESCRIPTION

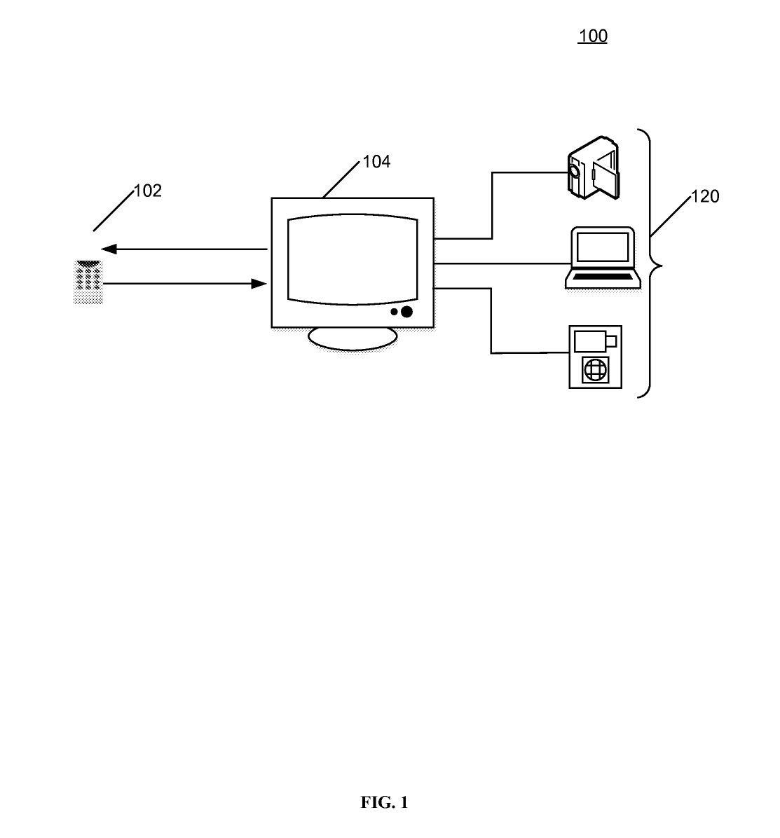

Turning to the Figures and to FIG. 1 in particular, a simplified block diagram of an electronic system is shown and generally indicated at 100. The electronic system 100 includes a bi-directional remote control (also referred to herein as a two-way remote control) 102, an electronic console device 104 and a set (meaning one or more) of external signal input devices 120 connected to the console device 104. The remote control 102 communicates with the console device 104 over a wireless link, such as an infra-red (“IR”) link, a Bluetooth link, a WiFi link, etc. The communication between the remote control 102 and the console device 104 is bi-directional. In other words, the remote control 102 sends commands to the console device 104, and receives commands from the console device 104. The commands, such as turning on and turning off the console device 104, and signal input device selection confirmation, are carried by wireless signals.

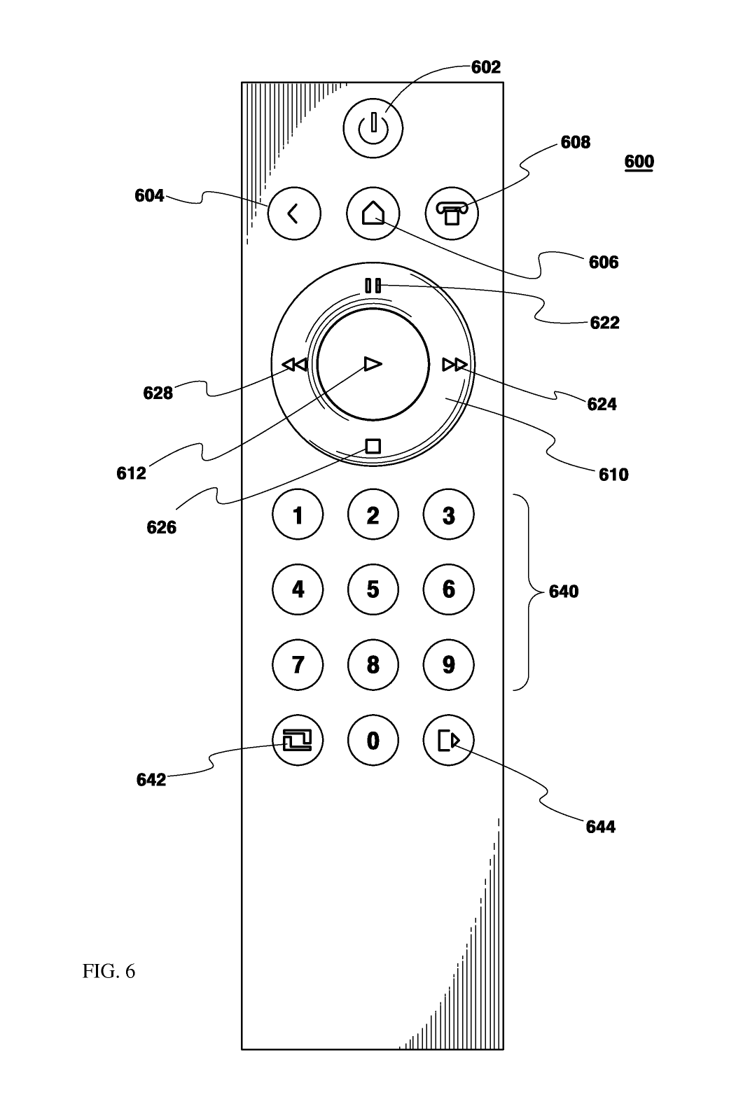

The remote control 102 is further illustrated by reference to FIG. 6, a front view of the remote control 102 is shown. In the illustrative embodiment, the remote control 102 incorporates a power button 602, a back button 604, a home button 606, a menu button 608, a click wheel 610, a center button 612, a set of numeric keys 640, a setting button 642 and a signal switch button 644. The set of numeric keys 640 consists of ten numeric keys for entering the numerals 0, 1, 2, 3, 4, 5, 6, 7, 8 and 9. Clicking of the back button 604 switches to a previous state or action, such as a previous screen displayed on the console device 104. Clicking the home button 606 causes a home or index screen to be shown on the console device 104. The menu button 608 functions to display a menu on the console device 104.

Clicking the setting button 642 causes a settings screen to be displayed on the console device 104 for the user to configure and/or select a setting(s) for operating the system 100. Alternatively, the setting button 642 functions as an on-screen display button, clicking of which causes the console device 104 to display program and playback information, such as the playback position of the media currently played by an external signal input devices 120, or the program or media meta data of the media. The signal switch button 644 allows the user to select a particular signal input device 120 to the console device 104, such as a DVD player, a video game device, a computer, etc.

The click wheel 610 includes four click wheel buttons 622, 624, 626 and 628. The click wheel buttons 622-628 provides various functions for operating an external signal input device 120. For example, the click wheel buttons 622-628 functions as directional up, right, right and left buttons. As an additional example, the click wheel button 624 allows the user to fast forward the playback of a media, such as a movie or song; the click wheel button 628 allows the user to rewind the media; the click wheel button 622 allows the user to pause the media; the click wheel button 626 allows the user to stop the playback of the media; and the center button 612 allows the user to start the playback of the media and/or stop the playback of the media, or make a selection.

Turning back to FIG. 1, each external signal input device in the set of signal input devices 120 is connected to the console device 104, and provides input (such as video and audio signals) to the console device 104. The console device 104 displays video images and plays back sound produced by the signal input devices 120. In one implementation, only one signal input device is selected to provide input to the console device 104. The selected signal input device is thus termed herein as the active signal input device. In a further implementation, more than one signal input device is selected. For example, one selected signal input device provides video input while the other selected signal input device provides audio input to the console device 104. As used herein, it is said that the remote control 102 and the set of signal input devices 120 are operatively coupled to the console device 104.

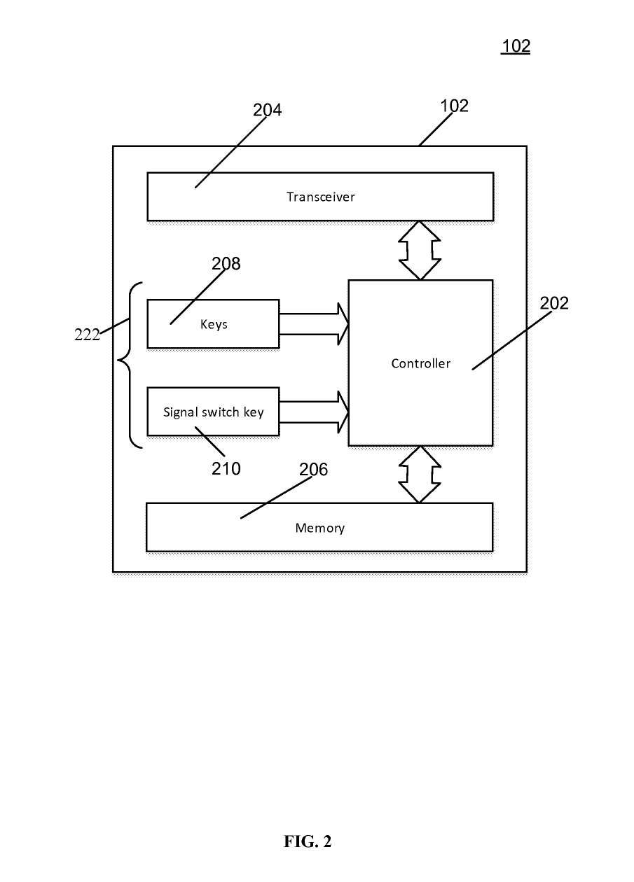

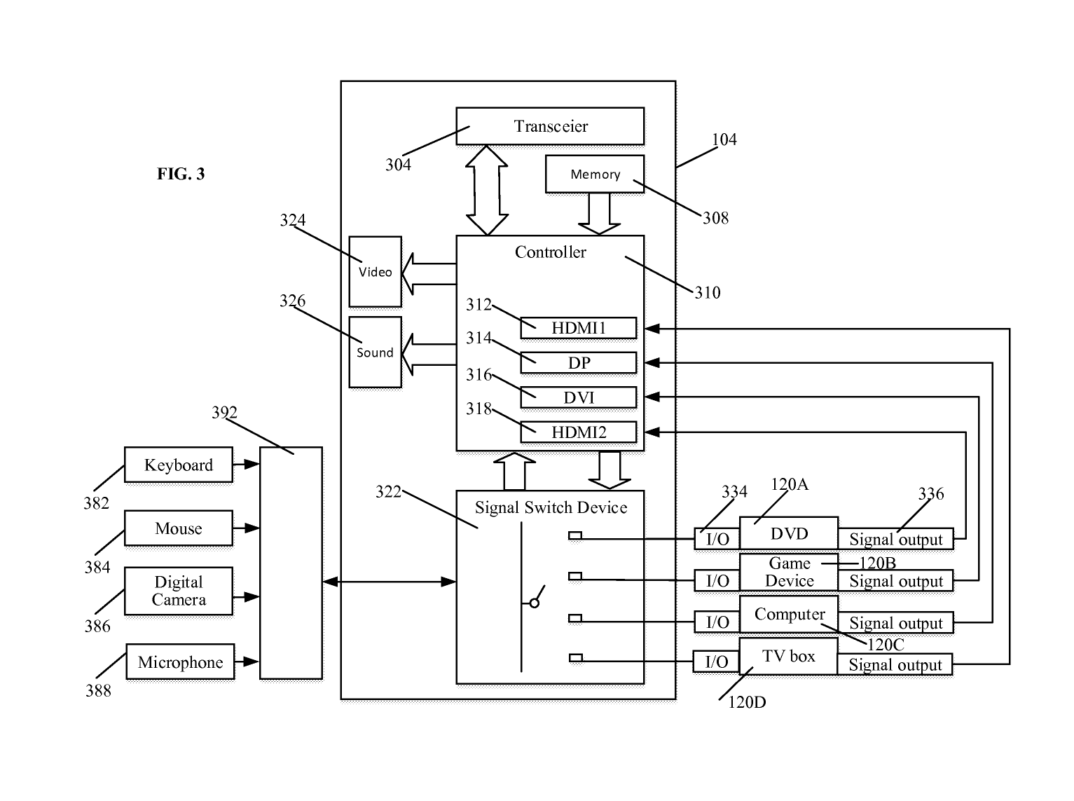

The system components of the system 100 are further illustrated by reference to FIG. 2 and FIG. 3. Turning first to FIG. 2, a simplified block diagram of the remote control 102 is shown. The remote control 102 includes a controller (such as a single chip microcontroller running firmware) 202, a wireless link transceiver 204, a user input device 222, and a memory 206. The transceiver 204, the user input device 222 and the memory 206 are operatively coupled to the controller 202. The transceiver 204 includes a transmitter and a receiver. Alternatively, the transmitter and the receiver are separate electronic components without common circuitry. The wireless link transceiver 204 can be, for example, an IR transceiver, a Bluetooth transceiver, or a WiFi transceiver. It should be noted that the transceiver 204, the user input device 222, the memory 206, and the controller 202 are disposed within a housing (not shown).

In one implementation, the user input device 222 includes a set of keys 208 and a separate signal switch key (such as the signal switch button 644) 210. For example, the keys 208 include the buttons 602-628 and the numeric keys 640. Pressing a key 208 causes the controller 202 to send a command to the console device 104 using the transceiver 204. Pressing the signal switch key 210 causes the controller 202 to send the console device 104 a command to select a different external signal input device 120. A predetermined function of a key (or button) is performed by the system 100 when the key is pressed or released. As used herein, pressing a key and releasing the key each are referred to as operating the key. The memory, such as Read-only-memory (“ROM”) stores computer programs for performing various functions of the system 100. The controller 202 reads data, such as stored computer programs, from the memory 206 for execution. The computer programs can be computer firmware or application software. The remote control 102 is powered by a set of batteries, rechargeable or not.

Referring FIG. 3, a simplified block diagram of the console device 104 and the external signal input devices 120 is shown. The console device 104 includes a wireless link transceiver 304 communicating with the transceiver 204, a memory 308 for storing computer programs, a controller 310, a video device 324, a sound controller 326, a signal switch device 322 operatively coupled to the set of signal input devices 120, and a set of user input devices 382. The transceiver 304, the memory 308, the video device 324, the sound controller 326, and the signal switch device 322 are operatively coupled to the controller 310. The video device 324 includes a display screen for showing video images.

The sound controller 326 interfaces with an internal or external speaker system for playing back audio generated by the signal input devices 120. It should be noted that the transceiver 304, the memory 308, the video device 324, the signal switch device 322, and the controller 310 are disposed within a housing (not shown) of the console device 104. The set of user input devices 382 is connected to the console device 104 through a linking element 392. In one implementation, the linking element 392 is a Universal Serial Bus (“USB”) interface, which can be external to the console device 104 or an integral part of the console device 104. Alternatively, one or more of the user input devices 382-388 is directly connected to the active signal input device 120 through, for example, the I/O device 334. In such a case, the user input entered using the user input devices 382-388 are received by the active external signal input device 120 without passing through the console device 104.

The controller 310 supports a set of input interfaces, such as a first High-Definition Multimedia Interface (“HDMI”) interface 312, a Display Port (“DP”) interface 314, a Digital Visual Interface (“DVI”) interface 316, and a second HDMI interface 318. The interfaces 312-318 are adapted to receive signals from the set of external signal input devices 120, including, for example, a DVD player 120A, a video game device (such as a Xbox or a PlayStation 4) 120B, a computer (such as a laptop or desktop computer) 120C, and a TV box (or TV set-top box) 120D. Each signal input device 120 can include an input/out (“I/O”) component for receiving user input, such as button, keyboard, mouse, camera, and microphone input. In addition, each signal input device 120 includes a signal output component for transmitting output signals to the controller 310. For example, the signal input device 120A includes an I/O component 334 and a signal output device 336.

In one implementation, at any point in time, only one of the signal input device 120 is selected as the active signal input device. Only the active signal input device receives user input from the external user input devices, such as a keyboard (or keypad) 382, a pointing device (such as a mouse) 384, a digital camera 386, and a microphone 388. In addition, only the active signal input device receives user input entered using the remote control 102. Furthermore, the active input device may receive user input entered using an input means (not shown), such as a set of buttons, provided by the console device 104.

Selection of the active signal input device from the set of signal input devices 120 is performed by the controller 310 through the signal switch device 322. In one implementation, the signal input devices in the set of signal input devices 120 are selected in a round-robin manner. For example, when the signal input device 1208 is currently the active signal input device, pressing the signal switch key (also referred to herein as a button) 210 causes the controller 310 to select the signal input device 120C as the active signal input device.

When a signal input device, such as the signal input device 120B, is selected as the active signal input device, the signal switch device 322 operatively couples the user input devices 382-388 with the device 120B. User input entered using the user input devices 382-388 is directed or passed to the signal input device 120B. For example, the I/O component 334 is operatively coupled to the linking element 392 such that user input entered using the user input devices 382-388 is received by the device 120B. In addition, user input entered using the remote control 102 is received using the transceiver 304 and directed to the signal input device 120B.

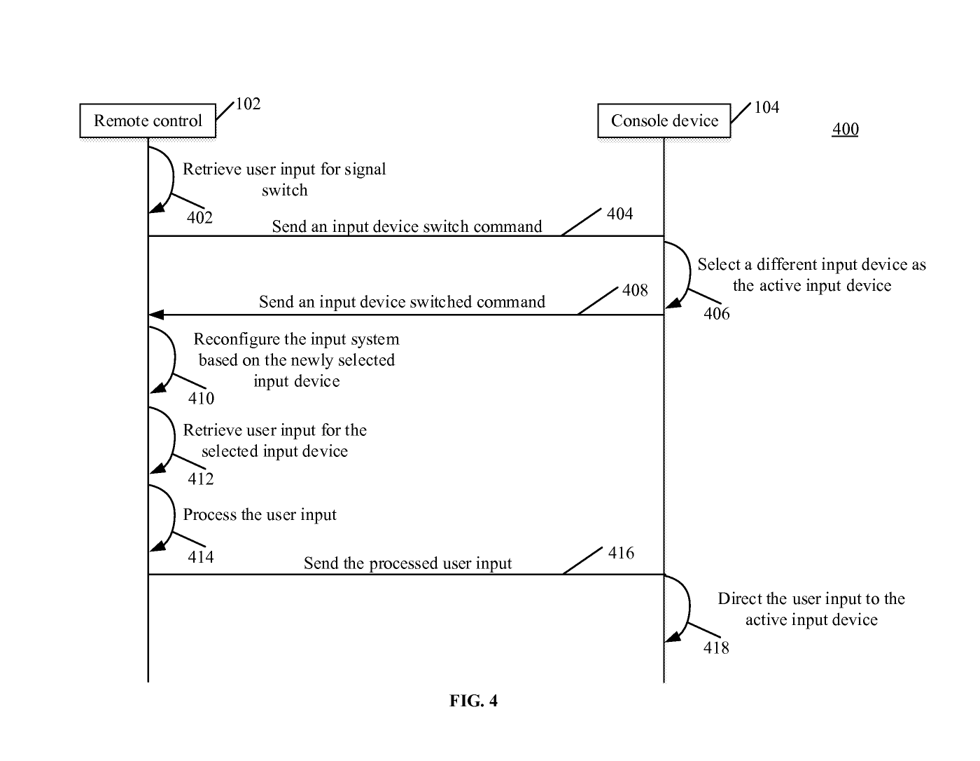

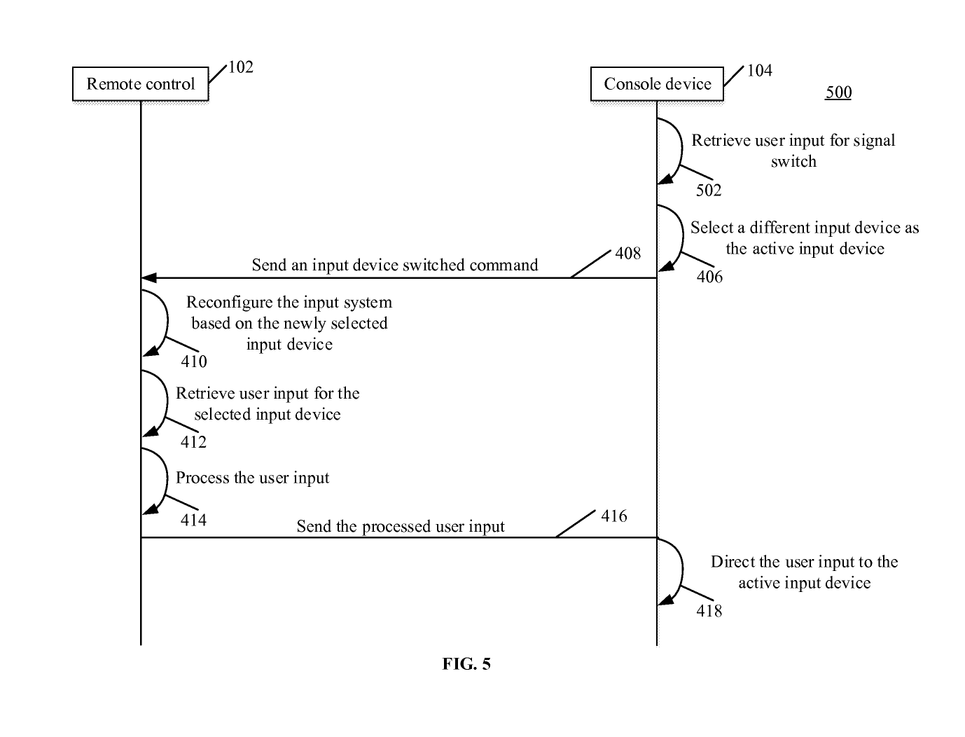

The video and audio output produced by the signal input device 120B is transmitted to the controller 310 or the video device 324 directly. Video output is displayed on the video device 324, while audio output is played out through a sound system (not shown), including a set of speakers, connected to the console device 104. The active signal input device selection process is further illustrated by reference to FIGS. 4 and 5.

Referring first to FIG. 4, a sequence diagram depicting a process by which the system 100 selects an active signal input device is shown and generally indicated at 400. The process 400 is performed by the system 100 when a user uses the remote control 102 to initiate the switching of the active signal input device. In other words, the user uses the remote control to selects a different signal input device from the currently active signal input device by, for example, pressing the signal switch key 210. At 402, the controller 202 retrieves the user input for signal switch (meaning selecting a different signal input device). At 404, the controller 202 sends a signal input device switch command to the console device 104 using the transceiver 204. At 406, the controller 310 receives the command from the transceiver 304 from the remote control 102. In response, at 406, the console device 104 selects a different signal input device as the active signal input device. For example, the controller 310 selects the signal input device that is immediately after the current active device in a predetermined order of the signal input devices 120.

The predetermined order is stored in the memory 308. The controller 310 operates the signal switch device 322 to perform the selection of the new active signal input device from the signal input devices 120 operatively coupled to the console device 104. After the switch is performed by the console device 104, at 408, the console device 104 sends a signal input device switched command to the remote control 102 through the transceiver 304. In one implementation, the signal input device switched command includes an identifier (“ID”) indicating the newly selected signal input device.

At 410, the remote control 102 receives the signal input device switched command. In addition, at 410, the controller 202 reconfigures the input system of the remote control 102 based on the new active signal input device. For example, based on the ID of the active signal input device, the controller 202 loads from the memory 206 or selects an input processing program corresponding to the active signal input device as the current (or active) input processing program. Each input processing program is stored in the memory 206. It is executed by the controller 202 to preprocess user input entered by the user using the remote control 102. As used herein, the user input system includes the user input device 222 and the active input processing program.

At 412, the user operates the remote control 102 to control the active signal input device. In other words, the user uses the remote control 102 to operate the active signal input device. For example, the user enters input using the keys (or buttons) 208 to operate the active signal input device, such as the video game device 120B. In such a case, at 412, the controller 202 retrieves the user input entered by the user using the keys 208. At 414, the user input is preprocessed by the active input processing program. For example, when the user holds down an “Up” key, the active input processing program generates an Up key down command every 0.1 seconds, 1 second or 3 seconds, depending on the specific input processing program. The Up key down command is sent to the console device 104 at 416. It should be noted that the preprocessing process of user input may not alter or modify the user input data at all. In such a case, the user input, such as a key press or release, is sent to the console device 104 without being modified by the active input preprocessing program. As used herein, the unmodified user input is also referred to as preprocessed user input.

At 418, the console device directs the user input received from the remote control 102 to the active signal input device. In addition, user input entered using the user input devices 382-388 is also fed to the active signal input device. It should be noted that, for the same user action, such as pressing and releasing the same key, different input processing programs may respond differently.

In a further implementation, the console device 104 provides a user input device, such as signal switch button (not shown), for the user to select external signal input devices 120. Operating this signal switch button triggers a different active signal input device selection process that is further illustrated by reference to FIG. 5.

Referring FIG. 5, a sequence diagram depicting a process 500 by which the system 100 switches an external signal input device is shown. At 502, the controller 310 retrieves the user input for signal switch. At 406, the controller 310 selects a different signal input device as the active signal input device. In such a case, a predetermined signal input device (such as the first one in set 120) is selected as the active signal input device.

Obviously, many additional modifications and variations of the present disclosure are possible in light of the above teachings. Thus, it is to be understood that, within the scope of the appended claims, the disclosure may be practiced otherwise than is specifically described above. For example, when a different external signal input device is selected as the active signal input device, commands indicating how user input should be preprocessed for the new active signal input device are sent to the remote control 102. As an additional example, the console device 104 can be a TV; and the external signal input devices can be connected to the Internet for downloading content, such as multimedia content or video game files. As still a further example, the communication protocol between the remote control 102 and the console device 104 can be proprietary or compliant with an industry standard.

The foregoing description of the disclosure has been presented for purposes of illustration and description, and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It is intended that the scope of the disclosure not be limited by the specification, but be defined by the claims set forth below. In addition, although narrow claims may be presented below, it should be recognized that the scope of this invention is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional inventions are not dedicated to the public and the right to file one or more applications to claim such additional inventions is reserved.

What is claimed is:

1. A bi-directional remote control comprising:
i) a controller;
ii) a first transceiver operatively coupled to said controller, said first transceiver adapted to send wireless signals to and receive wireless signals from a second transceiver of a console device;
iii) a user input device operatively coupled to said controller, said user input device including a signal switch key;
iv) a set of user input processing programs corresponding to a set of external signal input devices operatively coupled to said console device, each program in said set of user input processing programs adapted to be executed by said controller for preprocessing user input entered using said user input device; and
v) wherein said controller is adapted to:
1) send a signal input device switch command using said first transceiver to said console device when said signal switch key is operated, wherein said console device selects an active signal input device operatively coupled to said console device in response to said signal input device switch command, and sends a signal input device switched command to said remote control using said second transceiver;
2) receive said signal input device switched command using said first transceiver, said signal input device switched command indicating said active signal input device;
3) from said set of user input processing programs, select an active input processing program corresponding to said active signal input device in response to said signal input device switched command; and
4) send user input entered using said user input device and preprocessed by said active input processing program to said console device using said first transceiver.

2. The bi-directional remote control of claim 1, wherein said first transceiver is an IR transceiver, a Bluetooth transceiver, or a WiFi transceiver.

3. The bi-directional remote control of claim 1 further comprising a memory, said memory storing said set of user input processing programs.

4. The bi-directional remote control of claim 3, wherein said memory is a ROM.

5. A console device comprising:
i) a controller supporting a set of input interfaces for receiving signals from a set of external signal input devices;
ii) a first transceiver operatively coupled to said controller, said first transceiver adapted to send wireless signals to and receive wireless signals from a second transceiver of a bi-directional remote control;
iii) a video device operatively coupled to said controller, said video device adapted to display video images received from said set of external signal input devices;
iv) a signal switch device operatively coupled to said controller and said set of external signal input devices; and
v) wherein said controller is adapted to:
1) receive a signal input device switch command from said bi-directional remote control using said first transceiver;
2) responsive to said signal input device switch command, select an active signal input device from said set of external signal input devices using said signal switch device;
3) send a signal input device switched command to said bi-directional remote control using said first transceiver;
4) receive user input entered using said bi-directional remote control; and
5) direct said user input to said active signal input device.

6. The console device of claim 5, wherein said signal switch device is operatively coupled to a set of user input devices, and said active signal input device receives user input entered using said set of user input devices.

7. The console device of claim 6, wherein said set of user input devices includes at least one of a keyboard, a pointing device, a digital camera or a microphone.

8. The console device of claim 5, wherein said set of signal input devices includes at least one of a video game device, a DVD player, a computer or a TV set-top box.

9. The console device of claim 5, wherein said controller supports a set of input interfaces for receiving signal output from said set of signal input devices.

10. The console device of claim 9, wherein said set of input interfaces includes at least one of a HDMI interface, a DP interface or a DVI interface.

11. The console device of claim 5 further comprising a memory for storing a set of computer programs.

12. The console device of claim 11, wherein said memory is a ROM.

13. The console device of claim 5 further comprising a sound controller.
